(19) United States
(12) Patent Application Publication
(10) Pub. No.: US 2022/0215252 A1
(43) Pub. Date: Jul. 7, 2022

(54) METHOD AND SYSTEM FOR INITIALIZING A NEURAL NETWORK

(71) Applicant: IMAGIA CYBERNETICS INC., Montréal (CA)

(72) Inventors: Farsheed VARNO, Montréal (CA); Behrouz Haji SOLEIMANI, Montréal (CA); Marzie SAGHAYI, Montréal (CA); Lisa DI JORIO, Montréal (CA); Stan MATWIN, Montréal (CA)

(73) Assignee: IMAGIA CYBERNETICS INC., Montréal, QC (CA)

(21) Appl. No.: 17/609,296

(22) PCT Filed: May 7, 2020
(86) PCT No.: PCT/IB2020/054350

§ 371 Date: Nov. 5, 2021

Related U.S. Application Data
(60) Provisional application No. 62/844,472, filed on May 7, 2019.

(51) Int. Cl. G06N 3/08

(52) U.S. Cl. CPC G06N 3/08

(57) ABSTRACT

A method and a system are disclosed for initializing a pre-trained neural network, the method comprising obtaining a pre-trained neural network having an output layer, amending the output layer of the pre-trained neural network, wherein the amending comprises updating each weight of the output layer according to a function that maximizes the entropy of the output classes probability, wherein the function depends on a parameter controlling a proportion of error of the output classes probability such as it decreases the variance of the output classes probability, and providing the initialized pre-trained neural network.

### RELATED APPLICATION

The present application claims priority from U.S. provisional application No. 62/844,472 filed on May 7, 2019, the content of which is incorporated herein in its entirety.

### FIELD

One or more embodiments of the invention pertain to artificial intelligence. More precisely, one or more embodiment of the invention pertain to a method and a system for initializing a neural network.

### BACKGROUND

Artificial Neural Networks (ANNs) have shown a great capacity in learning complicated tasks and have become the first contender to solve many problems in the machine learning community. However, a large training dataset is a key pre-requisite for these networks to achieve good performances. This limitation has opened a new chapter in neural network research, which attempts to make learning possible with limited amounts of data. So far, one of the most widely used techniques to cope with such hindrance is the initialization of parameters based on the prior knowledge obtained from already trained models.

To adapt a pre-trained model to a new task, usually task-specific, extraneous and random parameters are transplanted to a meaningful set of representations, resulting in a heterogeneous model [1,6,17,19]. Training these unassociated modules together may contaminate the genuinely learned representations and significantly degrade the maximum transferable knowledge. Current fine-tuning techniques slow down the training process to compensate for this knowledge leak [17] which undermines fast convergence of a model that suffers from data-shortage.

Previous studies on parameters initialization of ANNs [2, 7, 8, 14] focus on preserving the variance, or other statistics, of the flowing data along the depth. This stabilizes the model and makes training deeper networks possible. Arpit and Bengio [2] recently showed that the initialization introduced in [8] is the optimal one for a ReLU network trained from scratch. [2] recommended to use the fan-out mode which preserves the variance of the back-propagated error along the depth. He et al. [8], inconsistently exempted the last layer of the models used for their experiments from the distribution for weights that they have recommended. This layer's distribution is stated to be found experimentally and no justification has been provided for its outcome. Such a strategy could be traced down to the earlier practices in constructing deep neural networks [21].

Recent studies on transfer learning use variance preserving initialization techniques for fine-tuning [17, 20]. However, it can be shown that using such techniques, initially contaminates the transferred knowledge, resulting in unguided modification of valuable transferred features.

Careful initialization is also an inevitable part of self-normalized neural networks introduced in [14]. These networks use Scaled Exponential Units (SELUs) as their activation function.

In feature extraction [3, 4], the pre-trained features are only used in inference mode and corresponding parameters remain intact during training. This protects the learned representations from undesired contamination but also prevents the required new task-specific features to be learned.

Fine-tuning [6] lets the pre-trained features and augmented parameters learn the target task together. Fine-tuning usually performs better than feature extraction and training from scratch with random initialization [6]. However, the pre-trained features are substantially contaminated due to noise flowing from random layers to the loss and from there, back-propagated toward the features.

There is a need for at least one of a method and a system that will overcome at least one of the above-identified drawbacks.

### SUMMARY

According to a broad aspect, there is disclosed a method for initializing a pre-trained neural network, the method comprising obtaining a pre-trained neural network having an output layer, amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and providing the initialized pre-trained neural network.

In accordance with one or more embodiments, the amending of the output layer of the pre-trained neural network further comprises z-normalizing features located right before the output layer prior updating each weight.

In accordance with one or more embodiments, the pre-trained neural network uses softmax logit in the output layer.

In accordance with one or more embodiments, there is disclosed a method for training a pre-trained neural network, the method comprising obtaining a pre-trained neural network to train; obtaining a dataset suitable for said training; initializing the pre-trained neural network using the method disclosed above; training the initialized pre-trained neural network using the obtained dataset; and providing the trained neural network.

In accordance with one or more embodiments, the training is a federated learning method.

In accordance with one or more embodiments, the training is a meta-learning method.

In accordance with one or more embodiments the training is a distributed machine learning method.

In accordance with one or more embodiments the training is a network architecture search using said pre-trained neural network as a seed.

In accordance with one or more embodiments, the pre-trained neural network comprises a generative adversarial network, wherein said initializing of the pre-trained neural network using the method disclosed above is performed at the discriminator.

In accordance with a broad aspect, there is disclosed method for training a neural network through federated learning, the method comprising obtaining a shared neural network to train; obtaining at least two datasets suitable for said federated learning, each of the at least two datasets for training a corresponding decentralized training unit; each decentralized training unit performing a first round of training using a corresponding dataset; for each subsequent round of training: each decentralized training unit initializing the shared neural network using the method disclosed above, each decentralized training unit training the initialized shared neural network using the corresponding dataset, globally federating the learning from all decentralized training units to a resulting global shared neural network, and until the global shared neural network converges to a good global model, providing the corresponding global shared neural network to the decentralized training units as the new shared neural network; and providing the trained shared neural network.

In accordance with a broad aspect, there is disclosed a method for training a neural network using a reptile meta-learning method, the method comprising obtaining a neural network to train; obtaining a dataset suitable for said reptile meta-learning method; for each iteration of the reptile meta-learning method: initializing the neural network using the method as disclosed above for each task sampled, and training the initialized neural network for said corresponding sampled task using the obtained dataset; and providing the trained neural network.

In accordance with one or more embodiments, the training of the initialized pre-trained neural network comprising training the initialized pre-trained neural network using a first training batch of the obtained dataset, wherein the first training batch is smaller than a number of features fed to said last layer of said initialized pre-trained neural network.

In accordance with a broad aspect, there is disclosed a method for using a pre-trained neural network trained in accordance with a method disclosed above.

In accordance with a broad aspect, there is disclosed a computer comprising a central processing unit; a graphics processing unit; a communication port; a memory unit comprising an application for initializing a pre-trained neural network, the application comprising: instructions for obtaining a pre-trained neural network having an output layer, instructions for amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and instructions for providing the initialized pre-trained neural network.

In accordance with a broad aspect, there is disclosed a computer program comprising computer-executable instructions which, when executed, cause a computer to perform a method for initializing a pre-trained neural network, the method comprising obtaining a pre-trained neural network having an output layer, amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and providing the initialized pre-trained neural network.

In accordance with a broad aspect, there is disclosed a non-transitory computer readable storage medium for storing computer-executable instructions which, when executed, cause a computer to perform a method for initializing a pre-trained neural network, the method comprising obtaining a pre-trained neural network having an output layer, amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and providing the initialized pre-trained neural network.

In accordance with a broad aspect, there is disclosed a method for initializing a neural network, the method comprising obtaining a neural network having an output layer, amending the output layer of the neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and providing the initialized neural network.

An advantage of one or more embodiments of the method disclosed is that they significantly decrease the initial noise that is back-propagated from randomly-initialized parameters toward layers that contain the transferred knowledge. As a consequence, a processing device used for training a neural network according to one or more embodiments of the method disclosed herein will use less resources for training a neural network resulting in more available resources available to complete other tasks. Moreover, one or more embodiments of the method disclosed herein may contribute to better performances overall compared to other traditional training methods, and does significantly contribute to bettering performances in training cases including a small number of training steps compared to other traditional training methods which is particularly useful to evaluate model potential during architecture search & design. Also, one or more embodiments of the method disclosed herein may contribute to decrease the negative impact of catastrophic forgetting, that may occur during model training across tasks, as it limits the impact of noise propagation.

In fact, experiments show that models trained by one or more embodiments of the method disclosed herein learn substantially faster than those using prior art fine-tuning or even more complicated tricks such as warm up [17].

Another advantage of one or more embodiments of the method disclosed is that they are easy to implement and can be beneficially applied to any pre-trained neural network that estimates output probabilities using softmax logits in one embodiment. As a consequence, a benefit is a broad applicability and integration across various deep learning frameworks offered by various vendors such as Google TensorFlow and Facebook PyTorch.

The optimal parameter initialization is derived for neural networks being fine-tuned on pre-trained models for classification and show that such optimal initial loss leads to a significant acceleration in adapting a pre-trained neural network to a new task.

Another advantage of one or more embodiments of the method disclosed is that they are independent of the choice of architecture and may be applied to transfer knowledge within any domain. As a consequence, a benefit is that one or more embodiments of the method disclosed herein do not increase the complexity of the overall architecture to be trained (e.g. no additional layer, no multi-stage training process like warm up methods).

Another advantage of one or more embodiments of the method disclosed herein is that they show a significant practical impact on convergence. As a consequence, a processing device used for training a neural network according to one or more embodiments of the method disclosed herein will use less resources for training a neural network than with a conventional methods, resulting in more available resources available to complete other tasks. One or more embodiments of the method disclosed herein may contribute to better performances overall compared to other traditional training methods, and does significantly contribute to bettering performances in training cases including a small number of training steps compared to other traditional training methods which is particularly useful to evaluate model potential during architecture search & design. One or more embodiments of the method disclosed herein may contribute to decrease the negative impact of catastrophic forgetting, that may occur during model training across tasks, as it limits the impact of noise propagation.

### BRIEF DESCRIPTION OF THE DRAWINGS

FIGS. 1a and 1b are graphs which show the negative effect of classical transfer learning techniques on the variance of the output layer on two benchmarks (MNIST and CIFAR), using state of the art models. Both graphs highlight the “noise injection” phenomenon.

FIGS. 2a and 2b are diagrams which show respectively an FNN architecture and last layer initialization in a base model and in accordance with one embodiment of the method disclosed.

FIG. 3 is a flowchart which shows an embodiment of a method for initializing a pre-trained neural network.

FIG. 4 is a flowchart which shows an embodiment of a method for training a pre-trained neural network which uses an embodiment of the method disclosed in FIG. 3.

FIG. 5 is a diagram which shows an embodiment of a processing device which may be used for initializing a pre-trained neural network in accordance with an embodiment.

FIG. 6 is a table which illustrates an initial percentage of noise energy to total energy of back-propagated error at the output of the last layer, profiled for models fine-tuned using regular fine-tuning; 95% confidence interval is calculated over 24 seeds.

FIG. 7 shows a plurality of graphs and illustrates test accuracy progress for fine-tuning models that are pre-trained on ImageNet dataset.

FIG. 8a is a table which illustrates average initial test accuracy improvement by using one embodiment of the method disclosed herein.

FIG. 8b is a table which illustrates convergence test accuracy of models trained on CIFAR10 dataset with 95% confidence.

FIG. 8c is a table which illustrates convergence test accuracy of models trained on CIFAR100 dataset with 95% confidence.

FIG. 9 is a table which illustrates convergence test accuracy of models trained on Caltech101 dataset with 95% confidence.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e g.” explains that “instructions” are an example of “data” that the computer may send over the Internet, and also explains that “a data structure” is an example of “data” that the computer may send over the Internet. However, both “instructions” and “a data structure” are merely examples of “data” and other things besides “instructions” and “a data structure” can be “data.”

The term “′” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, one or more embodiments of the present invention are directed to a method and a system for initializing a pre-trained neural network and its use for training a pre-trained neural network.

It will be appreciated that one or more embodiments of the method disclosed herein may be implemented according to various embodiments.

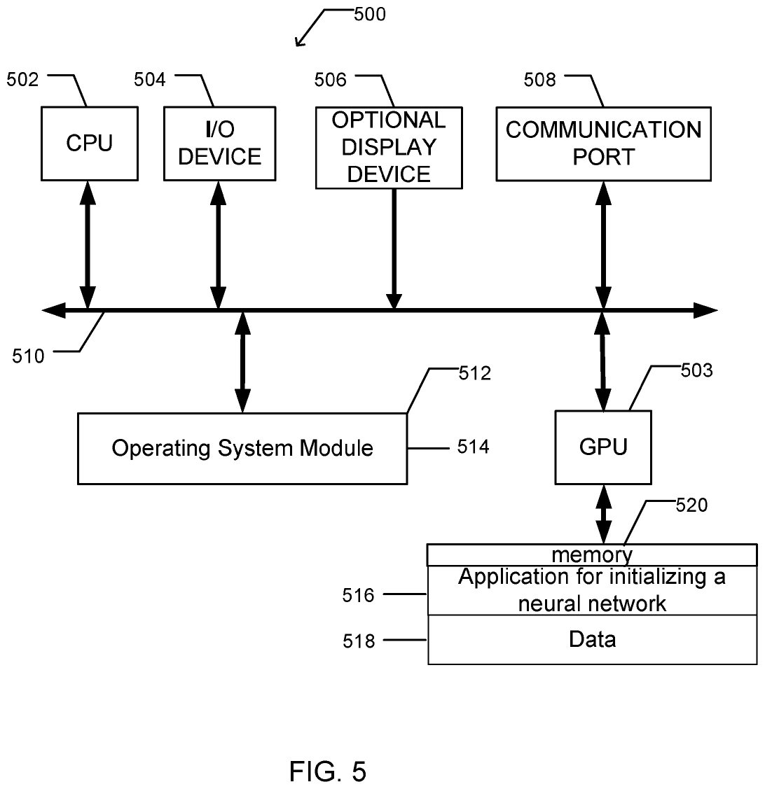

More precisely and now referring to FIG. 5, there is shown an embodiment of a processing device 500 which may be used for implementing a method for initializing a pre-trained neural network.

In fact, it will be appreciated that the processing device 500 may be any type of computer.

In one embodiment, the processing device 500 is selected from a group consisting of desktop computers, laptop computers, tablet PC's, servers, smartphones, etc.

In the embodiment shown in FIG. 5, the processing device 500 comprises a central processing unit (CPU) 502, also referred to as a microprocessor, a graphic processing unit (CPU) 503, input/output devices 504, an optional display device 506, communication ports 508, a data bus 510 and a memory unit 512.

The central processing unit 502 is used for processing computer instructions. The skilled addressee will appreciate that various embodiments of the central processing unit 502 may be provided.

In one embodiment, the central processing unit 502 comprises a CPU Intel i9-7920X manufactured by Inter™.

The graphics processing unit 503 is used for processing specific computer instructions. It will be appreciated that a memory unit 520 is operatively connected to the graphics processing unit 503.

In one embodiment, the graphics processing unit 503 comprises a GPU Titan V manufactured by Nvidia™.

The input/output devices 504 are used for inputting/outputting data into the processing device 500.

The optional display device 506 is used for displaying data to a user. The skilled addressee will appreciate that various types of display device 506 may be used.

In one embodiment, the optional display device 506 is a standard liquid crystal display (LCD) monitor.

The communication ports 508 are used for operatively connecting the processing device 500 to various processing devices.

The communication ports 508 may comprise, for instance, universal serial bus (USB) ports for connecting a keyboard and a mouse to the processing device 500.

The communication ports 508 may further comprise a data network communication port such as an IEEE 802.3 port for enabling a connection of the processing device 508 with another processing device.

The skilled addressee will appreciate that various alternative embodiments of the communication ports 508 may be provided.

The memory unit 512 is used for storing computer-executable instructions.

The memory unit 512 may comprise a system memory such as a high-speed random access memory (RAM) for storing system control program (e.g., BIOS, operating system module, applications, etc.) and a read-only memory (ROM). In one embodiment, the memory unit 512 has 128 GB of DDR4 RAM.

It will be appreciated that the memory unit 512 comprises, in one embodiment, an operating system module 514.

It will be appreciated that the operating system module 514 may be of various types.

In one embodiment, the operating system module 514 is Linux Ubuntu 18.04+Lambda Stack.

In one embodiment, the memory unit 520 comprises an application 516 for initializing a pre-trained neural network.

In one embodiment, the memory unit 520 operatively connected to the graphics processing unit 503 and has a size of 24 GB of VRAM. The skilled addressee will appreciate that various alternative embodiments may be possible.

The memory unit 520 is further used for storing data 518. The skilled addressee will appreciate that the data 518 may be of various types.

In fact, it will be appreciated that the memory unit 520 of the graphics processing unit 503 is further used for storing at least a portion of data referred to as the batch size. The skilled addressee will appreciate that a larger batch size “may” improve the effectiveness of the optimization steps resulting in more rapid convergence of the model parameters, and a larger batch size can also improve performance by reducing the communication overhead caused by moving the training data to the graphics processing unit 503—causing more compute cycles to run on the card with each iteration.

In one embodiment, the processing device 500 is a 4GPU Deep learning workstation manufactured by Lambda Quad.

### Flow of Data and Error

It will be appreciated that a Feed-forward Neural Network (FNN) is usually built by stacking up a number of layers on top of each other. The input of a layer can be composed of any combination of the previous layers' outputs. Let the input and output of the f-th layer of an FNN having L layers be X^{l} and A^{l} respectively. They are related to each other through functions g(.) and h(.) as

X^{L}=g^{l}(A¹,A², . . . ,A^{l-1});A^{l}=h^{l}(X^{l},W^{l},b^{l}) (1)

where W^{l}∈ [symbol] ^{U×V} and b^{l}∈ [symbol] ^{1×V} are weights and biases from the l-th layer and V is the number of columns in X^{l}.

If the target task is classification with C classes, then the last layer is usually a fully connected one with A^{L}∈ [symbol] ^{N×C} where N is the number of examples passing through the network, known as batch size. Specifically for this layer

A^{L}=X^{L}W^{L}^{^{T}}+\vec{1}b^{L}, (2)

where \vec{1} is a column vector of ones.

Since many formulas are batch independent and could be easily broadcast, lower-case bold-face letters of corresponding introduced matrices are separately used to indicate a single example in the batch (N=1). Therefore,

Equation 2 could be rewritten for a single example as

α^{L}=x^{L}W^{L}^{^{T}}+b^{L} (3)

The posterior of the last layer's neurons, corresponding to each class, is usually estimated using a softmax normalizer, defined as

$${\hat{y}}^{j} = \frac{{e}^{{a}_{j}^{L}}}{{\sum }_{i = 1}^{C} {e}^{{a}_{j}^{L}}} , \qquad ( 4 )$$

where aⱼ^{L} represents the j-th element of aL.

It will be appreciated that cross entropy is the most commonly used loss function for classification tasks and is equal to the Kullback-Leibler divergence between the labels and the estimates) [symbol] =−D_{KL}(Y,Ŷ). To train the network using back-propagation [10], gradients of the loss with respect to each parameter are calculated. To make this easier using the chain rule, first, the gradients are computed with respect to the output of each layer as in

$${δ}^{L} = {∇}_{{a}^{l}} ℒ = [ \frac{\partial ℒ}{\partial {a}_{1}^{l}} \frac{\partial ℒ}{\partial {a}_{2}^{l}} , … ] \qquad ( 5 )$$

and from there the desired gradients are calculated;

$$\frac{\partial ℒ}{\partial {W}_{j}^{l}} = {δ}_{j}^{l} \frac{\partial {h}^{l}}{\partial {W}_{j}^{l}} ; \frac{\partial ℒ}{\partial {b}_{j}^{l}} = {δ}_{j}^{l} \frac{\partial {h}^{l}}{\partial {b}_{j}^{l}} \qquad ( 6 )$$

where Wⱼ^{l} is the j-th row of W^{l}

The gradients of the CE loss with respect to the output of the j-th neuron of the deepest layer are equal to:

$${δ}_{j}^{L} = \frac{\partial ℒ}{\partial {a}_{j}^{L}} = \frac{1}{N} ( {\hat{y}}_{j} - {y}_{j} ) \qquad ( 7 )$$

and since the last layer is fully connected, the back-propagated error to the previous layer is also easily calculated using the chain rule:

δₖ^{L-1}=Σⱼ₌₁^{C}δⱼ^{L}W_{j,k}^{L} (8)

where W_{j,k}^{l} is the k-th element of Wⱼ^{L}. Finally, the weights and biases are updated using gradient descend.

Specifically for the last layer, the gradients of loss with respect to the rows of the weight matrix are:

∇Wⱼ^{L} [symbol] =N [symbol] _{N}[δⱼ^{L}x^{L}], (9)

where [symbol] _{N} is the expectation over the examples in the batch. Likewise the derivative of the loss with respect to a single bias in the last layer is:

$$\frac{\partial ℒ}{\partial {b}_{j}^{L}} = N {𝔼}_{N} [ {δ}_{j}^{L} ] \qquad ( 10 )$$

### Initialization

During the back-propagation algorithm [10], each data entry is passed twice through each layer's weights except the layers fed directly by the raw input. The magnitude of weights in a layer may get affected by the energy of the input visited by the layer, and the error back-propagated up to its output. Mathematically, it means that in Equations 6, a term of xi usually appears in the derivative of h^{l} with respect to the weights of the 1-th layer. This is already shown for the last layer in Equation 9. Weights are distinguished from biases and called such since they involve multiplication. This operation can rapidly increase/decrease the energy of its result, compared to the operands. This intensified/lessened energy of the output may increase/decrease the energy of the weights themselves through the gradient updates as discussed. This loop can lead to numerical problems known as exploding/vanishing gradients. One way of facing these problems is to initialize the weights and biases such that the energy of the flowing data/error is preserved. Currently, energy preserving initialization [9] is known to be the optimal solution for training ReLU networks [2].

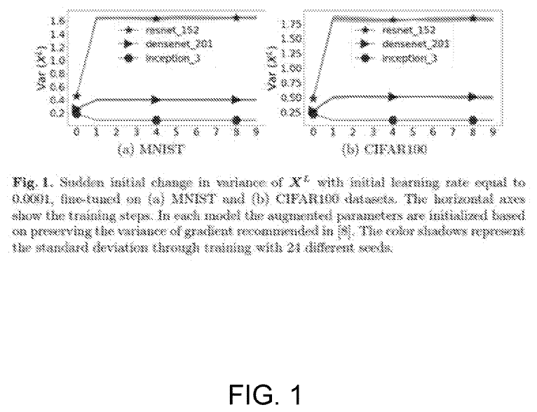

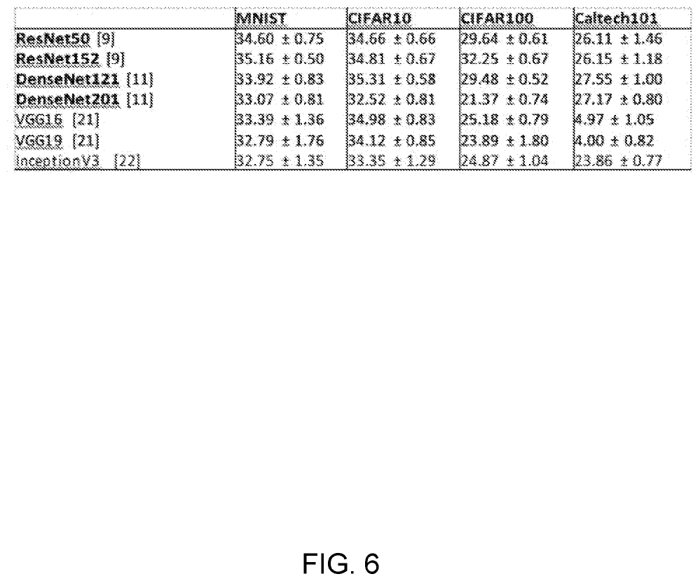

At the end of training a model on the source task, the magnitude of back-propagated errors goes toward zero. By switching the task and introducing randomly initialized layers, these errors are suddenly increased. Moreover, the optimization algorithm is usually restarted which causes updates to modify all the parameters with the same rate. These large back-propagated errors include considerable amounts of noise as shown in FIG. 6. This noise is injected into pre-trained knowledge through the first update. FIG. 1 shows the sudden initial changes in the variance of the input to the last layer when pre-trained models are fine-tuned.

The two common approaches to reduce this contamination are to slow down the training and/or to include a warm-up (WU) phase. However, the former slows down the contamination rather than eliminating it [17] since the small learning rate also updates the augmented parameters slowly, which injects noise into pre-trained layers for a longer time. In the latter solution, the new parameters are updated for a number of steps before jointly training the entire network.

FIG. 1. Sudden initial change in variance of X^{L} with initial learning rate equal to 0.0001, fine-tuned on (a) MNIST and (b) CIFAR100 datasets. The horizontal axes show the training steps. In each model the augmented parameters are initialized based on preserving the variance of gradient recommended in [8]. The color shadows represent the standard deviation through training with 24 different seeds.

The warm-up phase, the accuracy of the network is limited since most parts of the network are frozen. Additionally, the effective number of required training steps in the warm-up phase may be large, depending on the learning rate, initial values of augmented parameters and size of the dataset.

In a more effective approach, an initialization technique is disclosed herein for fine-tuning in which the noise is initially trapped only within the task-specific augmented parameters. In contrast to using the warm-up phase, in the method disclosed herein, the noise is always minimized after the first update and therefore the parameters can be trained altogether afterward. In addition, the method disclosed herein is easier to apply in the sense that the training process is not manipulated in any way.

Energy Components of Back-propagating Error

The energy consists of three components from which only one is directly correlated with the accuracy of the estimator and the two others are energies of the true labels and the estimates. The contribution of these components is disclosed and the lower and upper bounds for each one is found.

Let Φⱼ be the sum of energy of δⱼ^{L} through all examples of the batch, defined as:

Φⱼ= [symbol] _{N}[(Nδⱼ^{L})²]= [symbol] _{N}[(ŷⱼ−yⱼ)²]. (11)

Accordingly, using Equation 7, the total energy of the error over all examples in the batch and all C neurons of the last layer is equal to:

Φ=Σⱼ₌₁^{C}Φⱼ= [symbol] _{N}[ŷŷ^{T}]+ [symbol] _{N}[yy^{T}]−2 [symbol] _{N}[ŷy^{T}] (12)

Assuming the labels are one-hot encoded; the third term becomes the average probability assignment for the correct labels. The goal of training the model is to maximize this term which is bounded by 0≤ [symbol] _{N}[ŷy^{T}]≤1. The second term is the energy of the labels and is always equal to one, Finally, the first term is the energy of the estimates. The infimum of this term could be calculated using Cauchy-Schwarz inequality as follows:

$$\begin{matrix}{( y {\to }_{1} )}^{2} \leq ( {{\to }_{1}}^{T} {\to }_{1} ) ( \hat{y} {\hat{y}}^{T} ) & ( 13 ) \\ \hat{y} {\to }_{1} = {\sum }_{j = 1}^{C} {\hat{y}}_{j} = 1 ; {{\to }_{1}}^{T} {\to }_{1} = C & ( 14 ) \\ \hat{y} {\hat{y}}^{T} \geq \frac{1}{C} & ( 15 )\end{matrix}$$

This could also be derived directly from the definition of the softmax (Equation 4),

$$ζ = {\sum }_{j = 1}^{C} {\hat{y}}_{j}^{2} = {\sum }_{j = 1}^{C} \frac{{e}^{2 {a}_{j}^{L}}}{{( {\sum }_{i = 1}^{C} {e}^{{a}_{i}^{L}} )}^{2}} = \frac{{\sum }_{j = 1}^{C} {e}^{2 {a}_{j}^{L}}}{{( {\sum }_{i = 1}^{C} {e}^{{a}_{i}^{L}} )}^{2}} , \qquad ( 16 )$$

followed by taking the partial derivatives with respect to the inputs of the soft-max, setting it to zero and re-indexing gives:

$$\frac{\partial ζ}{\partial {a}_{i}^{L}} = \frac{2 {e}^{2 {a}_{k}^{L}} {\sum }_{i = 1}^{C} {e}^{{a}_{i}^{L}} - 2 {e}^{{a}_{k}^{L}} {\sum }_{j = 1}^{C} {e}^{2 {a}_{j}^{L}}}{{( {\sum }_{i = 1}^{C} {e}^{{a}_{i}^{L}} )}^{2}} = 0 ; \qquad ( 17 )$$

that results in:

Σₗ₌₁^{C}e^{a}^{ᵢ}^{^{L}}^{a}^{ₖ}^{^{L}}=Σⱼ₌₁^{C}e^{2a}^{ⱼ}^{^{L}}∀k, (18)

which means aⱼ^{L}=aₖ^{L}; j,k∈{1, 2, . . . , C}. Reforming Equation 16 considering equal elements in a^{L} finds minimum of ζ as:

$${ζ}_{min} = \frac{C {e}^{2 {a}_{j}^{L}}}{{( {e}^{{a}_{j}^{L}} )}^{2}} = \frac{1}{C}$$

The upper bound of the energy of the estimates equals to one and is achieved when their entropy is minimized per example, so

$$\frac{1}{C} \leq {𝔼}_{N} [ \hat{y} {\hat{y}}^{T} ] \leq 1.$$

All in all, the total energy of the back-propagated error is bounded between 0 and 2.

Here, the bounds for the energy of estimates are investigated. Using the definition of softmax, it is shown that to achieve the minimum of [symbol] _{N}[ŷŷ^{T}], all the neurons of the last layer should have per-example equal output.

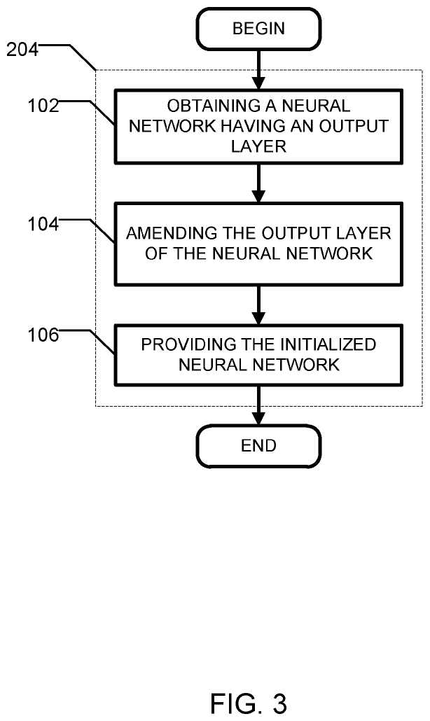

Now referring to FIG. 3, there is now shown an embodiment of a method for initializing a pre-trained neural network 100.

According to processing step 102, a pre-trained neural network is obtained. It will be appreciated that the pre-trained neural network has an output layer. In one embodiment, the pre-trained neural network uses softmax logit.

It will be appreciated that the pre-trained neural network may be provided according to various embodiments.

In one embodiment, the pre-trained neural network is received from a processing device. In another embodiment, the pre-trained neural network is obtained from a memory unit of the processing device. In another embodiment, the pre-trained neural network is provided by a user interacting with the processing device. The skilled addressee will appreciate that various alternative embodiments may be provided for providing the pre-trained neural network.

Still referring to FIG. 3 and according to processing step 104, the output layer of the pre-trained neural network is amended. It will be appreciated that the amending of the output layer of the pre-trained neural network comprises updating each weight of the output layer according to a function that maximizes the entropy of the output classes probability.

It will be appreciated that the function depends on a parameter controlling a proportion of error of the output classes probability such as it decreases the variance of the output classes probability.

In one embodiment, the amending of the output layer of the pre-trained neural network further comprises z-normalizing features located right before the output layer prior updating each weight.

It will be appreciated that in one embodiment, the initializing of the pre-trained neural network is performed to prevent adverse contamination during a training of the initialized pre-trained neural network.

According to processing step 106, the initialized pre-trained neural network is provided.

It will be appreciated that the initialized pre-trained neural network may be provided according to various embodiments. In one embodiment, the initialized pre-trained neural network is provided to a processing device. In another embodiment, the initialized pre-trained neural network is saved in a memory unit of the processing device. In another embodiment, the initialized pre-trained neural network is displayed to a user interacting with the processing device. The skilled addressee will appreciate that various alternative embodiments may be provided for providing the initialized pre-trained neural network.

While it has been disclosed in FIG. 3 that the method is used for initializing a neural network which is pre-trained, it will be appreciated that in one or more alternative embodiments, the neural network is not pre-trained.

In such embodiments, there is disclosed a method for initializing a neural network. The method comprises obtaining a neural network having an output layer.

It will be appreciated that the neural network may be provided according to various embodiments.

In one embodiment, the neural network is received from a processing device. In another embodiment, the neural network is obtained from a memory unit of the processing device. In another embodiment, the neural network is provided by a user interacting with the processing device. The skilled addressee will appreciate that various alternative embodiments may be provided for providing the neural network.

The method further comprises amending the output layer of the neural network. The amending of the output layer comprises updating each weight of the output layer according to a function that maximizes the entropy of the output classes probability. It will be appreciated that the function depends on a parameter controlling a proportion of error of the output classes probability such as it decreases the variance of the output classes probability.

The method further comprises providing the initialized neural network.

It will be appreciated that the initialized neural network may be provided according to various embodiments. In one embodiment, the initialized neural network is provided to a processing device. In another embodiment, the initialized neural network is saved in a memory unit of the processing device. In another embodiment, the initialized neural network is displayed to a user interacting with the processing device. The skilled addressee will appreciate that various alternative embodiments may be provided for providing the initialized neural network.

It will be appreciated that an embodiment of the method disclosed in FIG. 3 is detailed herein below.

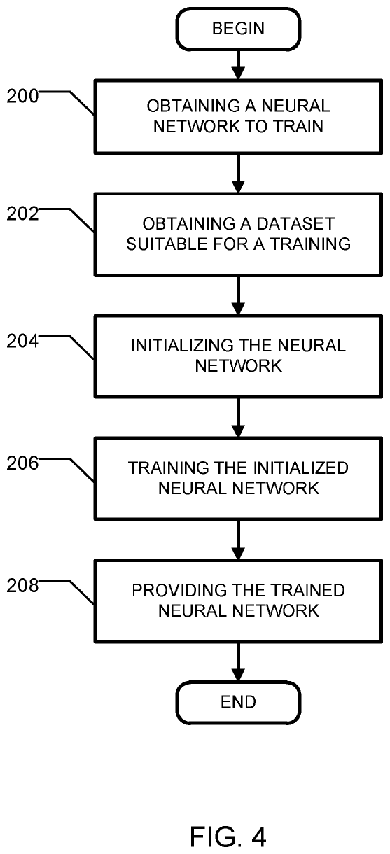

It will be appreciated that the initialized pre-trained neural network may be used when training the pre-trained neural network as disclosed for instance in FIG. 4.

More precisely and according to processing step 200, a pre-trained neural network to train is obtained.

As mentioned above, it will be appreciated that the pre-trained neural network may be obtained according to various embodiments.

According to processing step 202, a dataset suitable for the training is obtained.

It will be appreciated that the dataset suitable for the training may be obtained according to various embodiments.

In one embodiment, the dataset is obtained from a remote processing device operatively connected with a processing device.

According to processing step 204, the pre-trained neural network is initialized.

It will be appreciated that the pre-trained neural network may be initialized according to one or more embodiments of the method disclosed in FIG. 3.

According to processing step 206, the initialized pre-trained neural network is trained.

It will be appreciated that he initialized pre-trained neural network is trained using the dataset obtained.

In one or more embodiments, the training of the initialized pre-trained neural network comprises training the initialized pre-trained neural network using a first training batch of the obtained dataset, wherein the first training batch is smaller than a number of features fed to the last layer of the initialized pre-trained neural network.

It will be appreciated that in one or more embodiments, the training is a federated learning method. It will be appreciated that the federated learning method is disclosed at https://arxiv.org/pdf/1902.04885.pdf.

It will be appreciated that in one or more embodiments, the training is a meta-learning method. It will be appreciated that meta learning is disclosed for instance in the article “Human-level concept learning through probabilistic program induction” by Brenden M. Lake et al. Science 350, 1332 (2015).

It will be appreciated that in one or more embodiments, the training is a distributed machine learning method. It will be appreciated that the distributed machine learning method is disclosed at https://arxiv.org/abs/1810.06060.

It will be appreciated that in one or more other embodiments, the training is a network architecture search using the pre-trained neural network as a seed. It will be appreciated that the network architecture search is disclosed at https://arxiv.org/pdf/1802.03268.pdf.

It will be appreciated that in one or more embodiments, the pre-trained neural network comprises a generative adversarial network. In such embodiments, the initializing of the pre-trained neural network is performed at the discriminator.

Still referring to FIG. 4 and according to processing step 208, the trained neural network is provided.

It will be appreciated that the trained neural network may be provided according to various embodiments.

In one embodiment, the trained neural network is provided to a processing device. In another embodiment, the trained neural network is saved in a memory unit of the processing device. The skilled addressee will appreciate that various alternative embodiments may be provided for providing the initialized neural network.

It will be appreciated that there is also disclosed a method for training a neural network through federated learning.

It will be appreciated that the method comprises obtaining a shared neural network to train.

The method further comprises obtaining at least two datasets suitable for the federated learning. Each of the at least two datasets is used for training a corresponding decentralized training unit.

The method further comprises each decentralized training unit performing a first round of training using a corresponding dataset.

The method further comprises, for each subsequent round of training, each decentralized training unit initializing the shared neural network using one or more embodiments of the method disclosed above for initializing a pre-trained neural network and each decentralized training unit training the initialized shared neural network using the corresponding dataset.

The method further comprises globally federating the learning from all decentralized training units to a resulting global shared neural network, and until the global shared neural network converges to a good global model, providing the corresponding global shared neural network to the decentralized training units as the new shared neural network.

Finally, the method comprises providing the trained shared neural network. It will be appreciated that the trained shared neural network may be provided according to various embodiments. In one embodiment, the trained shared neural network is provided to a processing device. In another embodiment, the trained shared neural network is saved in a memory unit of the processing device. In another embodiment, the trained shared neural network is displayed to a user interacting with the processing device. The skilled addressee will appreciate that various alternative embodiments may be provided for providing the trained shared neural network.

It will be appreciated that there is also disclosed a method for training a neural network using a reptile meta-learning method. The method comprises obtaining a neural network to train.

The method further comprises obtaining a dataset suitable for the reptile meta-learning method. It will be appreciated that the reptile meta-learning method is disclosed at https://d4mucfpksywv.cloudfront.net/research-covers/reptile/reptile_update.pdf.

The method further comprises, for each iteration of the reptile meta-learning method, initializing the neural network using one or more embodiments of the method disclosed above for initializing a pre-trained neural network for each task sampled and training the initialized neural network for the corresponding sampled task using the obtained dataset.

Finally, the method comprises providing the trained neural network. It will be appreciated that the trained neural network may be provided according to various embodiments. In one embodiment, the trained neural network is provided to a processing device. In another embodiment, the trained neural network is saved in a memory unit of the processing device. In another embodiment, the trained neural network is displayed to a user interacting with the processing device. The skilled addressee will appreciate that various alternative embodiments may be provided for providing the trained neural network.

Detailed description of an embodiment of a method for initializing a neural network disclosed above

It will be appreciated that initially, the energy of the estimates contains pure noise, i.e. it lacks a meaningful relationship with either the inputs or the labels. Its infimum was calculated and it was shown that it can be achieved when all the estimates are exactly equal to each other for each example. This condition is intuitively appealing since it maximizes the entropy of the estimates prior to the training when y and ŷ are independent and/or unaligned. The entropy is exactly reflected in the CE loss which then becomes deterministically In C regardless of ŷ.

Another source of contaminating pre-trained layers is W^{L} itself. This is because δ^{L-1} is affected by both the last layer's error and its weights (see Equation 8). To prevent the noise from contaminating pre-trained layers an efficient solution should consider both of these criteria, One or more embodiments of a method are therefore introduced which maximizes the initial entropy of estimates while preventing δ^{L-1} to become contaminated by W^{L}. The method can be described as follows.

First and in accordance with an embodiment, the method requires the features that are fed to the last layer to be normalized. This is done by applying z-normalization across the batch,

$${\overline{x}}^{L} = \{ \begin{matrix}\frac{{x}^{L} - {μ}_{N}}{\sqrt{{σ}_{N}^{2} + ɛ}} , if train \\ \frac{{x}^{L} - {\hat{μ}}_{N}}{\sqrt{{\hat{σ}}_{N}^{2} + ɛ}} , if inference\end{matrix} ; {μ}_{N} , {\hat{μ}}_{N} , {σ}_{N}^{2} , {\hat{σ}}_{N}^{2} ϵ {1 \times k}^{} , \\ {μ}_{N} = {𝔼}_{N} [ {x}^{L} ] ; {μ}_{N} = detach ( {μ}_{N} ) , \\ {σ}_{N}^{2} = {𝔼}_{N} [ {( {x}_{i}^{L} - {μ}_{N} )}^{2} ] ; {\hat{σ}}_{N}^{2} = detach ( {σ}_{N} ) \qquad ( 20 )$$

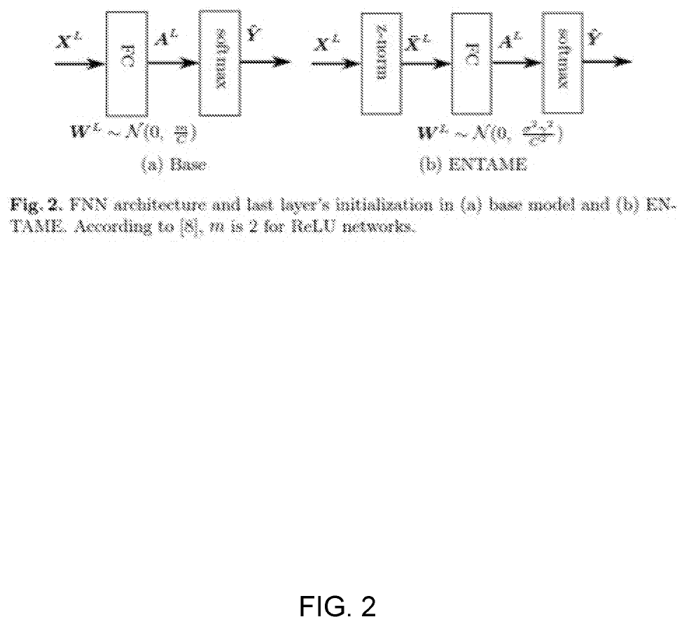

FIG. 2 shows a FNN architecture and last layer's initialization in (a) base model and (b) EN-TAME. According to [8], in is 2 for ReLU networks.

This is similar to batch-normalization [12], except that it does not need any learnable parameters. The statistics used in inference mode of the simple z-normalization are detached from the computational graph version of the ones obtained in the corresponding training step.

Second, the method maximizes the entropy of the estimates by initializing the last layer's weights to values drawn from Independent and Identically Distributed zero centered normal distribution as follows

$${W}^{L} \sim 𝒩 ( 0 , {ϕ}_{W} ) , {ϕ}_{w} = \frac{{γ}^{2} {λ}^{2}}{{C}^{2}} \qquad ( 21 )$$

where ϕ_{w} is the energy of each element of W^{L}, γ is the initial value of the learning rate (recommended default γ=10⁻⁴) and λ is a hyper-parameter that controls the proportion of noise energy over total energy of last layers weights, right after the first update (recommended range is 1 to 1000). ϕ_{w} is chosen to be a numerically small number (for example ϕ_{w}=10-12 means that 95% of the values in W^{L} are initially between −2×10⁻⁶ and 2×10⁻⁶), but it can be seen that such small randomness may help the expressiveness of the model. If the biases are also initialized constantly to all zeros and if K is not extremely large, the energy of a^{L} would be initially very small as well. Concretely, from the distribution selected for W^{L}, the value of each output neuron is approximately zero-centered, or [symbol] _{N}[a^{L}]≈\vec{0} and per-example energy of all output neurons together is

$${E}_{N} [ {\sum }_{j = 1}^{C} {a}_{j}^{{L}^{2}} ] = {𝔼}_{N} [ {a}^{L} {a}^{{L}^{T}} ] = {E}_{N} [ \overline{x} {W}_{j}^{T} {W}_{j} {\overline{x}}^{T} ] = K {ϕ}_{w} {𝔼}_{N} [ \overline{x} {\overline{x}}^{T} ] = \frac{{K}^{2} {ϕ}_{w}}{N} \qquad ( 22 )$$

This is derived from

$${𝔼}_{N} [ \overline{x} {\overline{x}}^{T} ] = \frac{1}{K} ,$$

due to x̅ trig normalized across the batch.

Moreover, the exponential function is close to linear when its input is close to zero. This could be easily shown by using the result of Equation 22, and the Taylor series approximation of the exponential function around zero, e^{a}^{ⱼ}^{^{L}}≈1+aⱼ^{L}. Plugging this into the softmax definition yields

$${\hat{y}}_{j} \approx \frac{1}{C} ,$$

which approximately maximizes the entropy as desired.

When the estimates are equal for each example, δⱼ^{L} becomes only a function of the prior, i.e.,

$${δ}_{j}^{L} = \{ \begin{matrix}\frac{1}{NC} , & if {y}_{j} = 0 \\ \frac{1}{N} ( \frac{1}{C} - 1 ) , & if {y}_{j} = 1\end{matrix} ; j ∈ \{ 1 , 2 , … , C \} . \qquad ( 23 )$$

Accordingly, the gradients of the loss with respect to last layer's parameters are simplified to

$$∇ {W}_{i}^{L} ℒ = {𝔼}_{N} [ ( \frac{1}{C} - {y}_{j} ) {\overline{x}}^{L} ] ; ∇ {b}_{j}^{L} ℒ = {𝔼}_{N} [ \frac{1}{C} - {y}_{j} ] . \qquad ( 24 )$$

Applying the updates results in

$${W}_{j}^{L , 1} = {W}_{j}^{L , 0} + {γ𝔼}_{N} [ {y}_{j} {\overline{x}}^{{1}_{J}} ] - γ \frac{1}{C} {𝔼}_{N} [ {\overline{x}}^{L} ] ; \\ {b}_{j}^{L , 1} ℒ = {γ𝔼}_{N} ⌈ {y}_{j} ] - γ \frac{1}{C} , \qquad ( 25 )$$

where γ is the initial learning rate and the second number in the superscripts represent the number of updates, e.g. Wⱼ^{l,u} indicates to the weights of the l-th layer after u updates. The error cannot move further backward at this point since Φ_{w} is very small, making δ^{L-1} negligible.

After the first update, the outputs of each neuron of the last layer can get comparably high expected values. This may cause the estimates to have much lower entropy compared to the initial state. On the other hand, depending on Y and X̅, multiple rows and columns of weights and corresponding elements of biases from the last layer can possibly get identical first updates (see Equation 24).

This may cause the entropy of the estimates to stay comparably high for each example. Very small random numbers, used to initialize W^{L}, help these identical estimates to diverge and make different estimates. It will be appreciated that as the expectation of aⱼ^{L} gets away from zero toward positive values, the exponential functions in softmax make the small difference much larger. Therefore, the expressiveness of the last layer is preserved by initializing its weights to very small numbers instead of zero.

The first update makes the energy of W^{L} large enough to let the error of the next updates back-propagate through it and reach the pre-trained layers. In other words, this automatically opens up the stalled way and lets the error to back-propagate to the output of other layers. This is enough for correctly guiding pre-trained parameters with an advanced optimization algorithm like Adam [13] is used. Most of the noise is purified and the next back-propagated errors toward pre-trained features are meaningful and contain both prior and likelihood. In more details, the energy of the j-th row in W^{L,1} becomes:

$$\begin{matrix}{W}_{j}^{L , 1} {W}_{j}^{L , {1}^{T}} = K {ϕ}_{w} + {γ}^{2} {𝔼}_{N} [ {( \frac{1}{C} - {γ}_{j} )}^{2} \overline{x} {\overline{x}}^{T} ] \\ = K {γ}^{2} \frac{{λ}^{2}}{{C}^{2}} + K {γ}^{2} \frac{1}{{NC}^{2}} + {γ}^{2} \frac{C - 2}{NC} {\sum }_{i = 1}^{N} {Y}_{i} {\overline{X}}_{i} {\overline{X}}_{i}^{T}\end{matrix} \qquad ( 26 )$$

which means:

$$\frac{K {γ}^{2}}{{C}^{2}} ( {λ}^{2} + \frac{1}{N} ) \leq {W}_{j}^{L , 1} {W}_{j}^{L , {1}^{T}} \leq \frac{K {γ}^{2}}{{C}^{2}} ( {λ}^{2} + \frac{1}{N} + \frac{C ( C - 2 )}{N} ) . \qquad ( 27 )$$

Energy of Wⱼ^{L,1} is

$$\frac{K}{N}$$

times the energy of j-th bias in the last layer. Since bⱼ^{L,1} contains only information about the prior, we desire to make its energy initially smaller than Wⱼ^{L,1}. For this to happen, initial N has to be chosen such that N<K (which usually is satisfied). On the other hand, λ should be chosen such that

$${λ}^{2} < \frac{1}{N}$$

but not very small to numerically reduce the rank of Wⱼ^{L,1} due to possible similar updates (see Equation 25), which may results in higher entropy of ŷ. Nλ² roughly determines the maximum proportion of remaining energy of noise to the total energy of elements of Wⱼ^{L,1}.

### Role of Feature Normalization

As mentioned above and in accordance with one or more embodiments, a feature normalization is performed. It will be appreciated that applying z-normalization on top of features may increase or decrease the level of average feature-wise energy in X^{L} resulting in less need for tweaking the learning rate and Φ_{w} for different tasks and even different models. If the values of X^{L} are too small, it may take a longer time for W^{L} to grow which leaves pre-trained features unchanged for a longer time.

In one or more embodiments, z-normalization is applied if the provided initialized pre-trained model is to be further trained on the provided data, where the provided data exhibits an important domain shift with respect to the data on which the model was pre-trained.

Z-normalization across batches plays a more important role than just equalization. To clarify, it is assumed that image classification is done and two images in a batch contain exactly the same pattern or visual object. If one of the columns of X^{L} represents a feature that recognizes said pattern, the feature is expected to reflect the presence of the pattern in both of the mentioned images equally. The problem is that raw inputs are usually normalized with statistics that are identically applied on all pixels in all examples. In the best case, such normalization is applied separately for different channels. Object-wise normalization does not seem to be feasible prior to detection which indirectly is done through training neural network classifier. Therefore, even if the same object is exactly copied in both images due to normalizing raw images, one object may get less intensified than the other one. This may directly be reflected to the values of the particular column of X^{L} responsible for showing the presence of the desired object. Z-normalization, compensates for this problem by normalizing the features after they are detected.

Batch-normalization layers used in between the hidden layers of some pre-trained models, usually need more training steps to adapt to the distribution of target task's data. Since we also care about the performance of the model in the first training steps, feeding normalized features to the last layer is vital. It will be appreciated that the simple z-normalization applied on X^{L}, directly influences the first update of W^{L}.

### Experiments

ImageNet [18] ILSVRC 2012 is the source dataset used to pre-train the models. Each pre-trained model is fine-tuned on the following datasets: MNIST [16]CIFAR10, CIFAR100 [15] and Caltech101 [5]. The latter dataset is not originally separated into train and test nor is balanced in contrast to the other ones. Each Caltech101 category is split randomly into train and test subsets with 15 percent chance of drawing each image for test subset.

Prior to feeding the input to the models, each channel is normalized with its mean and standard deviation obtained from all pixels of that channel throughout the corresponding training subset. Training images are also augmented with random horizontal flip.

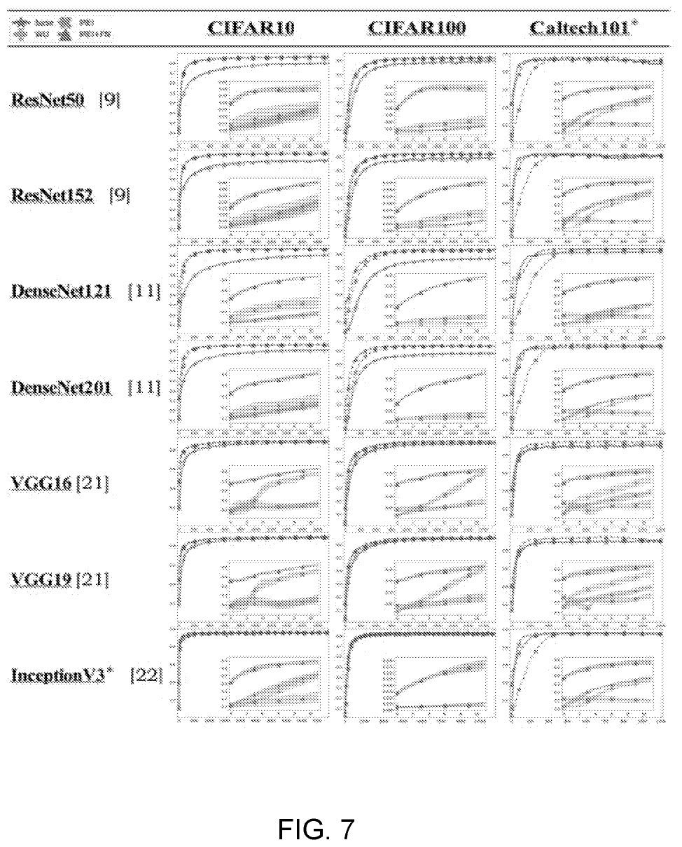

The set of used architectures are listed in the leftmost column of FIG. 7. Among these models InceptionV3 requires all images to be [symbol] up to 229 229, so due to limitations in device's memory the batch size of 64 is chosen for this architecture. In addition, the other models that are trained on the Caltech101 dataset are also fed 64 images per batch owning to large image sizes. All other models and dataset use batch size of 256.

The initialization recommended by [8] is used for augmented layers in the base models. A try was made to unify the problem by applying similar conditions for training different models as much as possible. This by itself would show the impact of one or more embodiments of the method disclosed and how universally it could help the task adaptation, even without considering hyper-parameter tuning. Accordingly, learning rate is set to 0.0001 for all models and datasets and the value of φw is chosen to be 10-12 everywhere.

FIG. 7 shows the progress of test accuracy of pre-trained models fine-tuned on each dataset. The smaller plot inside each larger one shows the same curves zoomed-in the first steps of training. The colorful shade around each curve shows the standard deviation across 24 different seeds. Each plot includes 4 curves color mapped as follows; blue: base, orange: base with a single Warm Up (WU) step, green: disclosed method's Maximum Entropy Initialization (MEI), red: full disclosed method or MEI+Feature Normalization (FN). Experiments were also done with only applying FN, but they mostly perform worse than all other cases, so they are not included to save space and make plots more readable.

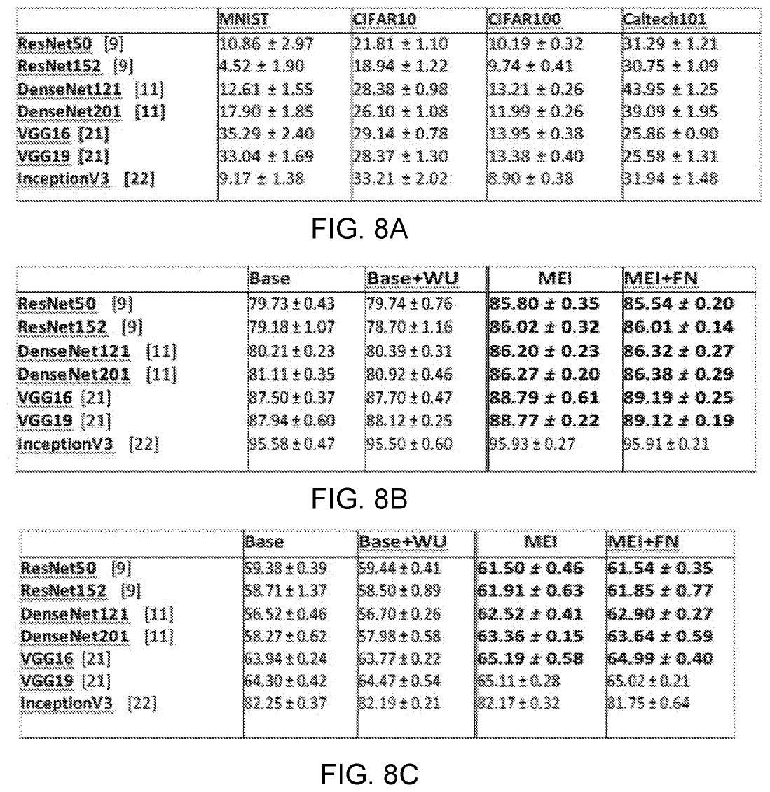

To measure how the convergence is sped up initially, average progressing accuracy is compared over first ten training steps. Paired t-test suggests that one or more embodiments of the method disclosed herein significantly enhances the test accuracy compared to the base method for all architectures and datasets mentioned herein. FIG. 8a shows the average increase in the accuracy of the first 10 training steps with 95% confidence. Further improvements have been observed by adjusting A and the batch size but to show the robustness of the model the same setup has been kept as much as possible.

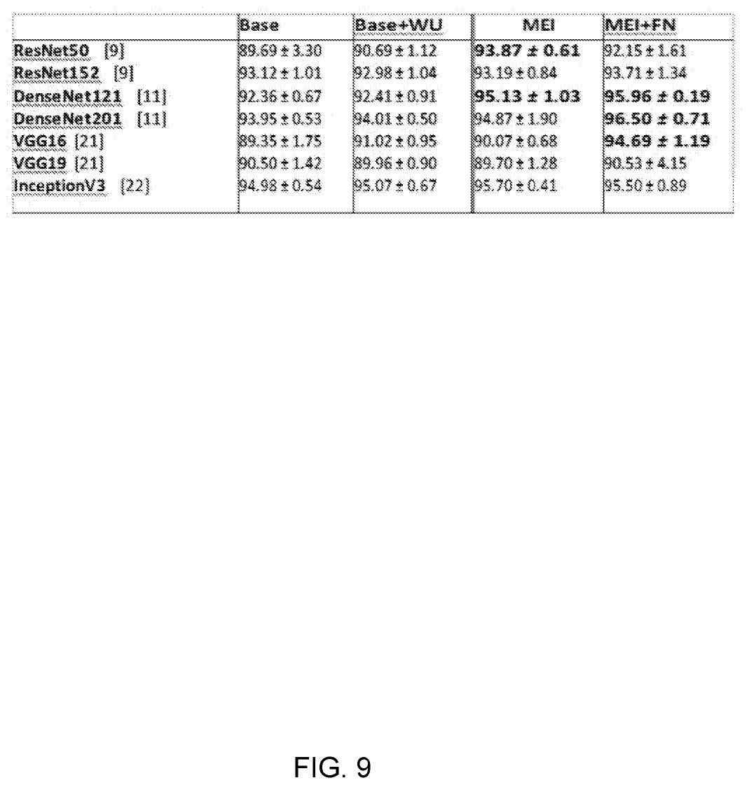

Finally, the converged accuracy of each curve shown in FIG. 7 is listed in FIGS. 8b, 8c and 9. The convergence test accuracy is recorded after training models for 10 epochs if target dataset is CIFAR10 or Caltech101 and 15 epochs if target dataset is CIFAR100. Further experiments have been done on ResNet [9], DenseNet [11] and VGG [21] with other popular sizes but similar results were obtained so results of the two most common sizes of each in the above-mentioned tables were only reported.

Now referring to FIG. 7, there is shown test accuracy progress for fine-tuning models that are pre-trained on ImageNet dataset. The horizontal axes on each plot show the number of training steps. Colorful shades show the standard deviation across different seeds. A superscript * means that all models in corresponding row or column are trained with batch size of 64 instead of 256 to make the model fit into the device. The smaller plots inside the bigger ones are just zoomed-in version of the same curves for the first few steps.

Now referring to FIG. 8a, there is shown average initial test accuracy improvement by using an embodiment of the method disclosed herein instead of base method. The entries show increase in the mean of test accuracy over first 10 steps of training with 95% confidence calculated over 24 seeds.

Now referring to FIG. 8b, there is shown convergence test accuracy of models trained on CIFAR10 dataset with 95% confidence.

Now referring to FIG. 8c, there is shown convergence test accuracy of models trained on CIFAR100 dataset with 95% confidence.

Now referring to FIG. 9, there is shown convergence test accuracy of models trained on Caltech101 dataset with 95% confidence. It will be appreciated that although a focus was done on image classification, the reasoning behind one or more embodiments of the method disclosed herein's impressive performance is not tied to image datasets in any way.

An important outcome of the empirical results is that models fine-tuned on datasets with 100 or even more classes show initial test accuracy of over 40% by visiting only the first 64 images. This can open-up a whole new discussion about the power of few-shot learning algorithms.

It will be appreciated that the application 516 for initializing a neural network comprises instructions for obtaining a pre-trained neural network having an output layer.

The application 516 for initializing a pre-trained neural network further comprises instructions for amending the output layer of the pre-trained neural network. The amending comprises updating each weight of said output layer according to a function that maximizes the entropy of the output classes probability. The function depends on a parameter controlling a proportion of error of the output classes probability such as it decreases the variance of the output classes probability.

The application 516 for initializing a pre-trained neural network further comprises instructions for providing the initialized pre-trained neural network.

It will be appreciated that there is also disclosed a non-transitory computer readable storage medium for storing computer-executable instructions which, when executed, cause a computer to perform a method for initializing a pre-trained neural network, the method comprising obtaining a pre-trained neural network having an output layer, amending the output layer of the pre-trained neural network, wherein the amending comprises updating each weight of the output layer according to a function that maximizes the entropy of the output classes probability, wherein the function depends on a parameter controlling a proportion of error of said output classes probability such as it decreases the variance of the output classes probability, and providing the initialized pre-trained neural network.

It will be appreciated that there is also disclosed a computer program comprising computer-executable instructions which, when executed, cause a computer to perform a method for initializing a pre-trained neural network, the method comprising obtaining a pre-trained neural network having an output layer, amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and providing the initialized pre-trained neural network.

It will be appreciated that there is also disclosed a method for using a pre-trained neural network trained in accordance one or more embodiments of the method disclosed herein.

It will be appreciated that one or more embodiments of the method disclosed herein are of great advantage for various reasons.

An advantage of one or more embodiments of the method disclosed is that they significantly decrease the initial noise that is back-propagated from randomly-initialized parameters toward layers that contain the transferred knowledge. As a consequence, a processing device used for training a neural network according to one or more embodiments of the method disclosed herein will use less resources for training a neural network resulting in more available resources available to complete other tasks. Moreover, one or more embodiments of the method disclosed herein may contribute to better performances overall compared to other traditional training methods, and does significantly contribute to bettering performances in training cases including a small number of training steps compared to other traditional training methods which is particularly useful to evaluate model potential during architecture search & design. Also, one or more embodiments of the method disclosed herein may contribute to decrease the negative impact of catastrophic forgetting, that may occur during model training across tasks, as it limits the impact of noise propagation.

In fact, experiments show that models trained by one or more embodiments of the method disclosed herein learn substantially faster than those using prior art fine-tuning or even more complicated tricks such as warm up [17].

Another advantage of one or more embodiments of the method disclosed is that they are easy to implement and can be beneficially applied to any pre-trained neural network that estimates output probabilities using softmax logits in one embodiment. As a consequence, a benefit is a broad applicability and integration across various deep learning frameworks offered by various vendors such as Google TensorFlow and Facebook PyTorch.

The optimal parameter initialization is derived for neural networks being fine-tuned on pre-trained models for classification and show that such optimal initial loss leads to a significant acceleration in adapting a pre-trained neural network to a new task.

Another advantage of one or more embodiments of the method disclosed is that they are independent of the choice of architecture and may be applied to transfer knowledge within any domain. As a consequence, a benefit is that one or more embodiments of the method disclosed herein do not increase the complexity of the overall architecture to be trained (e.g. no additional layer, no multi-stage training process like warm up methods).

Another advantage of one or more embodiments of the method disclosed herein is that they show a significant practical impact on convergence. As a consequence, a processing device used for training a neural network according to one or more embodiments of the method disclosed herein will use less resources for training a neural network than with a conventional methods, resulting in more available resources available to complete other tasks. One or more embodiments of the method disclosed herein may contribute to better performances overall compared to other traditional training methods, and does significantly contribute to bettering performances in training cases including a small number of training steps compared to other traditional training methods which is particularly useful to evaluate model potential during architecture search & design. One or more embodiments of the method disclosed herein may contribute to decrease the negative impact of catastrophic forgetting, that may occur during model training across tasks, as it limits the impact of noise propagation.

Clause 1: A method for initializing a pre-trained neural network, the method comprising:

obtaining a pre-trained neural network having an output layer,

amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and

providing the initialized pre-trained neural network.

Clause 2: The method as claimed in clause 1, wherein the amending of the output layer of the pre-trained neural network further comprises z-normalizing features located right before the output layer prior updating each weight.

Clause 3: The method as claimed in clause 1, wherein the pre-trained neural network uses softmax logit in the output layer.

Clause 4: A method for training a pre-trained neural network, the method comprising:

obtaining a pre-trained neural network to train;

obtaining a dataset suitable for said training;

initializing the pre-trained neural network using the method as claimed in any one of clauses 1 to 3;

training the initialized pre-trained neural network using the obtained dataset; and

providing the trained neural network.

Clause 5: A method as claimed in clause 4, wherein said training is a federated learning method.

Clause 6: A method as claimed in clause 4, wherein said training is a meta-learning method.

Clause 7: A method as claimed in clause 4, wherein said training is a distributed machine learning method.

Clause 8: The method as claimed in clause 4, wherein said training is a network architecture search using said pre-trained neural network as a seed.

Clause 9: The method as claimed in any one of clauses 4 to 8, wherein the pre-trained neural network comprises a generative adversarial network, wherein said initializing of the pre-trained neural network using the method as claimed in clause 1 is performed at the discriminator.

Clause 10: A method for training a neural network through federated learning, the method comprising:

obtaining a shared neural network to train;

obtaining at least two datasets suitable for said federated learning, each of the at least two datasets for training a corresponding decentralized training unit;

each decentralized training unit performing a first round of training using a corresponding dataset;

for each subsequent round of training:

each decentralized training unit initializing the shared neural network using the method as claimed in any one of clauses 1 to 3,

each decentralized training unit training the initialized shared neural network using the corresponding dataset,

globally federating the learning from all decentralized training units to a resulting global shared neural network, and
until the global shared neural network converges to a good global model, providing the corresponding global shared neural network to the decentralized training units as the new shared neural network; and

providing the trained shared neural network.

Clause 11: A method for training a neural network using a reptile meta-learning method, the method comprising:

obtaining a neural network to train;

obtaining a dataset suitable for said reptile meta-learning method;

for each iteration of the reptile meta-learning method:

initializing the neural network using the method as claimed in any one of clauses 1 to 3 for each task sampled, and
training the initialized neural network for said corresponding sampled task using the obtained dataset; and

providing the trained neural network.

Clause 12: The method as claimed in any one of clauses 4 to 9, wherein the training of the initialized pre-trained neural network comprising training the initialized pre-trained neural network using a first training batch of the obtained dataset, wherein the first training batch is smaller than a number of features fed to said last layer of said initialized pre-trained neural network.

Clause 13: A method for using a pre-trained neural network trained in accordance with any one of clauses 4 to 9.

Clause 14: A computer comprising:

a central processing unit;

a graphics processing unit;

a communication port;

a memory unit comprising an application for initializing a pre-trained neural network, the application comprising:
instructions for obtaining a pre-trained neural network having an output layer,
instructions for amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and
instructions for providing the initialized pre-trained neural network.

Clause 15: Computer program comprising computer-executable instructions which, when executed, cause a computer to perform a method for initializing a pre-trained neural network, the method comprising:

obtaining a pre-trained neural network having an output layer,

amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and

providing the initialized pre-trained neural network.

Clause 16: A non-transitory computer readable storage medium for storing computer-executable instructions which, when executed, cause a computer to perform a method for initializing a pre-trained neural network, the method comprising:

obtaining a pre-trained neural network having an output layer,

amending the output layer of the pre-trained neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and

providing the initialized pre-trained neural network.

Clause 17: A method for initializing a neural network, the method comprising:

obtaining a neural network having an output layer,

amending the output layer of the neural network, wherein said amending comprises updating each weight of said output layer according to a function that maximizes the entropy of the output classes probability, wherein said function depends on a parameter controlling a proportion of error of said output classes probability such as it decreases the variance of the output classes probability, and

providing the initialized neural network.

### REFERENCES

1. Agrawal, P., Girshick, R., Malik, J.: Analyzing the performance of multilayer neural networks for object recognition. In: European conference on computer vision. pp. 329-344. Springer (2014)
2. Arpit, D., Bengio, Y.: The benefits of over-parameterization at initialization in deep relu networks, arXiv preprint arXiv:1901.03611 (2019)
3. Azizpour, H., Razavian, A. S., Sullivan, J., Maki, A., Carlsson, S.: Factors of transferability for a generic convnet representation. IEEE transactions on pattern analysis and machine intelligence 38(9), 1790-1802 (2016)
4. Donahue, J., Jia, Y., Vinyals, O., Hoffman, J., Zhang, N., Tzeng, E., Darrell, T.: Decaf: A deep convolutional activation feature for generic visual recognition (2013)
5. Fei-Fei, L., Fergus, R., Perona, P.: Learning generative visual models from few training examples: An incremental bayesian approach tested on 101 object categories. Computer vision and Image understanding 106(1), 59-70 (2007)
6. Girshick, R., Donahue, J., Darrell, T., Malik, J.: Rich feature hierarchies for accurate object detection and semantic segmentation. In: Proceedings of the IEEE conference on computer vision and pattern recognition. pp. 580-587 (2014)
7. Glorot, X., Bengio, Y.: Understanding the difficulty of training deep feedforward neural networks. In: Proceedings of the thirteenth international conference on artificial intelligence and statistics. pp. 249-256 (2010)
8. He, K., Zhang, X., Ren, S., Sun, J.: Delving deep into rectifiers: Surpassing human-level performance on imagenet classification. In: Proceedings of the IEEE international conference on computer vision. pp. 1026-1034 (2015)
9. He, K., Zhang, X., Ren, S., Sun, J.: Deep residual learning for image recognition. In: Proceedings of the IEEE conference on computer vision and pattern recognition, pp. 770-778 (2016)
10. Hornik, K., Stinchcombe, M., White, H.: Multilayer feedforward networks are universal approximators. Neural networks 2(5), 359-366 (1989)
11. Huang, G., Liu, Z., Maaten, L.v.d., Weinberger, K. Q.: Densely connected convolutional networks. 2017 IEEE Conference on Computer Vision and Pattern Recognition (CVPR) (July 2017). https://doi.org/10.1109/cvpr.2017.243, http://dx.doi.org/10.1109/CVPR.2017.243
12. Ioffe, S., Szegedy, C.: Batch normalization: Accelerating deep network training by reducing internal covariate shift, arXiv preprint arXiv:1502.03167 (2015)
13. Kingma, D., Ba, J.: Adam: a method for stochastic optimization (2014). arXiv preprint arXiv:1412.6980 15 (2015)
14. Klambauer, G., Unterthiner, T., Mayr, A., Hochreiter, S.: Self-normalizing neural networks (2017)
15. Krizhevsky, A., Hinton, G.: Learning multiple layers of features from tiny images. Tech. rep., Citeseer (2009)
16. LeCun, Y., Bottou, L., Bengio, Y., Haffner, P., et al.: Gradient-based learning applied to document recognition. Proceedings of the IEEE 86(11), 2278-2324 (1998)
17. Li, Z., Hoiem, D.: Learning without forgetting, IEEE Transactions on Pattern Analysis and Machine Intelligence 40(12), 2935-2947 (2018)
18. Russakovsky, O., Deng, J., Su, H., Krause, J., Satheesh, S., Ma, S., Huang, Z., Karpathy, A., Khosla, A., Bernstein, M., et al.: Imagenet large scale visual recognition challenge. International journal of computer vision 115(3), 211-252 (2015)
19. Sharif Razavian, A., Azizpour, H., Sullivan, J., Carlsson, S.: Cnn features off-the-shelf: an astounding baseline for recognition. In: Proceedings of the IEEE conference on computer vision and pattern recognition workshops. pp. 806-813 (2014)
20. Shermin, T., Murshed, M., Lu, G., Teng, S. W.; Transfer learning using classification layer features of cnn (2018)
21. Simonyan, K., Zisserman, A.: Very deep convolutional networks for large-scale image recognition (2014)
22. Szegedy, C., Vanhoucke, V., Ioffe, S., Shlens, J., Wojna, Z.: Rethinking the inception architecture for computer vision. In: Proceedings of the IEEE conference on computer vision and pattern recognition. pp. 2818-2826 (2016)

1. A method for initializing a pre-trained neural network, the method comprising:
obtaining a pre-trained neural network having an output layer,
amending the output layer of the pre-trained neural network, wherein said amending comprises updating each weight of said output layer according to a function that maximizes an entropy of output classes probability, wherein said function depends on a parameter controlling a proportion of error of said output classes probability such as it decreases a variance of the output classes probability, and
providing the initialized pre-trained neural network.

2. The method as claimed in claim 1, wherein the amending of the output layer of the pre-trained neural network further comprises z-normalizing features located right before the output layer prior updating each weight.

3. The method as claimed in claim 1, wherein the pre-trained neural network uses softmax logit in the output layer.

4. A method for training a pre-trained neural network, the method comprising:
obtaining a pre-trained neural network to train;
obtaining a dataset suitable for said training;
initializing the pre-trained neural network using the method as claimed in claim 1;
training the initialized pre-trained neural network using the obtained dataset; and
providing the trained neural network.

5. The method as claimed in claim 4, wherein said training is a federated learning method.

6. The method as claimed in claim 4, wherein said training is a meta-learning method.

7. The method as claimed in claim 4, wherein said training is a distributed machine learning method.

8. The method as claimed in claim 4, wherein said training is a network architecture search using said pre-trained neural network as a seed.

9. The method as claimed in claim 4, wherein the pre-trained neural network comprises a generative adversarial network, wherein said initializing of the pre-trained neural network is performed at the discriminator.

10. A method for training a neural network through federated learning, the method comprising:
obtaining a shared neural network to train;
obtaining at least two datasets suitable for said federated learning, each of the at least two datasets for training a corresponding decentralized training unit;
each decentralized training unit performing a first round of training using a corresponding dataset;
for each subsequent round of training:
each decentralized training unit initializing the shared neural network using the method as claimed in claim 1,
each decentralized training unit training the initialized shared neural network using the corresponding dataset,
globally federating the learning from all decentralized training units to a resulting global shared neural network, and
until the global shared neural network converges to a good global model, providing the corresponding global shared neural network to the decentralized training units as the new shared neural network; and
providing the trained shared neural network.

11. A method for training a neural network using a reptile meta-learning method, the method comprising:
obtaining a neural network to train;
obtaining a dataset suitable for said reptile meta-learning method;
for each iteration of the reptile meta-learning method:
initializing the neural network using the method as claimed in claim 1 for each task sampled, and
training the initialized neural network for said corresponding sampled task using the obtained dataset; and
providing the trained neural network.

12. The method as claimed in claim 4, wherein the training of the initialized pre-trained neural network comprising training the initialized pre-trained neural network using a first training batch of the obtained dataset, wherein the first training batch is smaller than a number of features fed to said last layer of said initialized pre-trained neural network.

13. A method for using a pre-trained neural network trained in accordance with claim 4.

14. A computer comprising:
a central processing unit;
a graphics processing unit;
a communication port;
a memory unit comprising an application for initializing a pre-trained neural network, the application comprising:
instructions for obtaining a pre-trained neural network having an output layer,
instructions for amending the output layer of the pre-trained neural network, wherein said amending comprises updating each weight of said output layer according to a function that maximizes an entropy of output classes probability, wherein said function depends on a parameter controlling a proportion of error of said output classes probability such as it decreases a variance of the output classes probability, and
instructions for providing the initialized pre-trained neural network.

15. Computer program comprising computer-executable instructions which, when executed, cause a computer to perform a method for initializing a pre-trained neural network, the method comprising:
obtaining a pre-trained neural network having an output layer,
amending the output layer of the pre-trained neural network, wherein said amending comprises updating each weight of said output layer according to a function that maximizes an entropy of output classes probability, wherein said function depends on a parameter controlling a proportion of error of said output classes probability such as it decreases a variance of the output classes probability, and
providing the initialized pre-trained neural network.

16. A non-transitory computer readable storage medium for storing computer-executable instructions which, when executed, cause a computer to perform a method for initializing a pre-trained neural network, the method comprising:
obtaining a pre-trained neural network having an output layer,
amending the output layer of the pre-trained neural network, wherein said amending comprises updating each weight of said output layer according to a function that maximizes an entropy of output classes probability, wherein said function depends on a parameter controlling a proportion of error of said output classes probability such as it decreases a variance of the output classes probability, and
providing the initialized pre-trained neural network.

17. A method for initializing a neural network, the method comprising:
obtaining a neural network having an output layer,
amending the output layer of the neural network, wherein said amending comprises updating each weight of said output layer according to a function that maximizes an entropy of output classes probability, wherein said function depends on a parameter controlling a proportion of error of said output classes probability such as it decreases a variance of the output classes probability, and
providing the initialized neural network.
